(19) United States
(12) Patent Application Publication
(10) Pub. No.: US 2008/0043643 A1
(43) Pub. Date: Feb. 21, 2008

(54) Video encoder adjustment based on latency

(76) Inventors: Jeffrey L. Thielman, Corvallis, OR (US); Mark E. Gorzynski, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/492,393

(22) Filed: Jul. 25, 2006

(51) Int. Cl. H04L 12/16; H04Q 11/00

(52) U.S. Cl. 370/260

(57) ABSTRACT

Systems, methods, media, and other embodiments associated with video encoder adjustment based on latency are described. One exemplary controller embodiment includes a latency determination logic to determine latency between a first video conference node and a second video conference node, and, an encoder adjustment logic to adjust latency of a video encoder based, at least in part, upon the determined latency.

### BACKGROUND

Video conference systems employ video encoders to transmit data between conference sites via a network (e.g., a private computer network, the Internet etc.). Video encoders can be variable bit-rate or constant bit-rate. Variable bit-rate video encoders have been controlled by consuming more network bandwidth if bandwidth is available. Adjusting bit-rate based on available bandwidth can result in unnecessary consumption of valuable network bandwidth. Constant bit-rate video encoders employ a specific, constant bit-rate and can waste bandwidth over short network runs. Thus, conventional video conference encoder systems can consume available bandwidth without concern to the overall network.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that unless otherwise stated one element may be designed as multiple elements, multiple elements may be designed as one element, an element shown as an internal component of another element may be implemented as an external component and vice versa, and so on. Furthermore, elements may not be drawn to scale.

FIG. 1 illustrates an example controller.

FIG. 2 illustrates an example video encoding system.

FIG. 3 illustrates an example video encoding system.

FIG. 4 illustrates an example video conference system.

FIG. 5 illustrates an example method of modifying a video conference encoding system.

FIG. 6 illustrates an example computing environment in which example systems and methods illustrated herein may operate.

### DETAILED DESCRIPTION

Example systems, methods, computer-readable media, software and other embodiments are described herein that relate to controlling and/or adjusting a video encoder (e.g., coder/decoder (codec)) based, at least in part, upon latency. In a network connection, latency is a measure of the amount of time it takes for a packet to travel from a source to a destination. In general, latency and bandwidth define the delay and capacity of a network. Latency can impact the quality of video conferences. In one embodiment, a controller can be preprogrammed with acceptable latency quality threshold(s) in order to optimize latency without noticeably degrading quality.

In one embodiment, the controller can provide an encoder adjustment signal to adjust the video encoder based, at least in part, upon latency determined between a first video conference node and a second video conference node. For example, nodes in close proximity to one another that have low latency connections can have the latency increased without noticeably degrading video quality. Increased latency can result in reduced bandwidth consumption for the overall network. Thus, the controller can cause an encoder to adjust/change its encoding process for low latency connections to increase the latency to an allowable average level. By increasing the latency between selected nodes, other network nodes with high latency may be allotted more bandwidth, so that encoding latency can be reduced.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Machine-readable medium”, as used herein, refers to a medium that participates in directly or indirectly providing signals, instructions and/or data that can be read by a machine (e.g., computer). A machine-readable medium may take forms, including, but not limited to, non-volatile media (e.g., optical disk, magnetic disk), volatile media (e.g., semiconductor memory, dynamic memory), and transmission media (e.g., coaxial cable, copper wire, fiber optic cable, electromagnetic radiation). Common forms of machine-readable mediums include floppy disks, hard disks, magnetic tapes, CD-ROMs, RAMs, ROMs, carrier waves/pulses, and so on. Signals used to propagate instructions or other software over a network, like the Internet, can be considered a “machine-readable medium.”

“Logic”, as used herein, includes but is not limited to hardware, firmware, software and/or combinations thereof to perform a function(s) or an action(s), and/or to cause a function or action from another logic, method, and/or system. Logic may include a software controlled microprocessor, discrete logic (e.g., application specific integrated circuit (ASIC)), an analog circuit, a digital circuit, a programmed logic device, a memory device containing instructions, and so on. Logic may include a gate(s), a combination of gates, other circuit components, and so on. In some examples, logic may be fully embodied as software. Where multiple logical logics are described, it may be possible in some examples to incorporate the multiple logical logics into one physical logic. Similarly, where a single logical logic is described, it may be possible in some examples to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more computer instructions and/or processor instructions that can be read, interpreted, compiled, and/or executed by a computer and/or processor. Software causes a computer, processor, or other electronic device to perform functions, actions and/or behave in a desired manner. Software may be embodied in various forms including routines, algorithms, modules, methods, threads, and/or programs. In different examples software may be embodied in separate applications and/or code from dynamically linked libraries. In different examples, software may be implemented in executable and/or loadable forms including, but not limited to, a stand-alone program, an object, a function (local and/or remote), a servelet, an applet, instructions stored in a memory, part of an operating system, and so on. In different examples, computer-readable and/or executable instructions may be located in one logic and/or distributed between multiple communicating, co-operating, and/or parallel processing logics and thus may be loaded and/or executed in serial, parallel, massively parallel and other manners.

Suitable software for implementing various components of example systems and methods described herein may be developed using programming languages and tools (e.g., Java, C, C#, C++, SQL, APIs, SDKs, assembler). Software, whether an entire system or a component of a system, may be embodied as an article of manufacture and maintained or provided as part of a machine-readable medium. Software may include signals that transmit program code to a recipient over a network or other communication medium.

Some portions of the detailed descriptions that follow are presented in terms of algorithm descriptions and representations of operations on electrical and/or magnetic signals capable of being stored, transferred, combined, compared, and otherwise manipulated in hardware. These are used by those skilled in the art to convey the substance of their work to others. An algorithm is here, and generally, conceived to be a sequence of operations that produce a result. The operations may include physical manipulations of physical quantities. The manipulations may produce a transitory physical change like that in an electromagnetic transmission signal.

It has proven convenient at times, principally for reasons of common usage, to refer to these electrical and/or magnetic signals as bits, values, elements, symbols, characters, terms, numbers, and so on. These and similar terms are associated with appropriate physical quantities and are merely convenient labels applied to these quantities. Unless specifically stated otherwise, it is appreciated that throughout the description, terms including processing, computing, calculating, determining, displaying, automatically performing an action, and so on, refer to actions and processes of a computer system, logic, processor, or similar electronic device that manipulates and transforms data represented as physical (electric, electronic, magnetic) quantities.

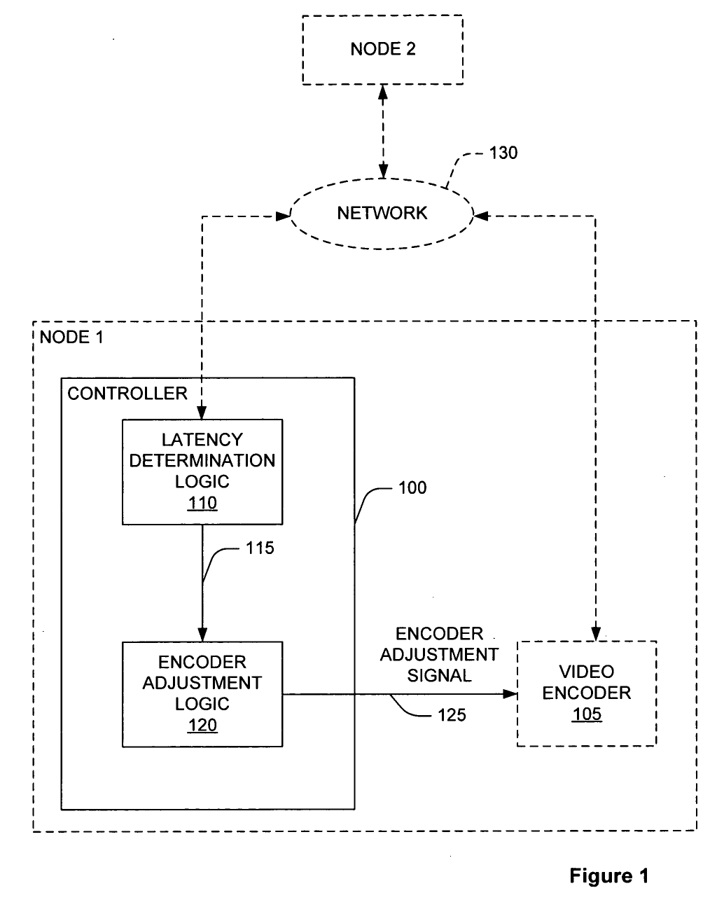

FIG. 1 is a block diagram that illustrates an example controller 100 to adjust a video encoder 105 (e.g., coder/decoder (codec)). It will be appreciated that various components are shown in FIG. 1 in phantom since they are illustrated to assist in describing the controller 100 but are not part of the system of the controller 100. Other system embodiments described herein can include one or more of these components in combination with each other, including a modified example of FIG. 1.

With reference to FIG. 1, the controller 100 can provide an encoder adjustment signal 125 to adjust the video encoder 105 based, at least in part, upon latency determined between a first video conference node 1 and a second video conference node 2. Nodes 1 and 2 can communicate with each other via a network 130. Increasing latency for selected network connections, for example, by increasing latency for nodes in close proximity to one another, can result in reduced overall network bandwidth consumption. For example, latency intensive tasks include motion adaptation, inclusion of bi-predictive frames (B-type frames), multi-pass encoding and the like. These tasks consume time (latency) but result in lower bandwidth for a given quality level.

In one embodiment, the controller 100 includes latency determination logic 110 to determine latency between the first node and the second node. The determined latency is provided as a determined latency signal 115.

In one example, at connection initiation, the latency determination logic 110 can measure the network latency between the first node and the second node. In a second embodiment, the latency determination logic 110 can periodically measure network latency in order to dynamically react, for example, to changes in network traffic and/or topology.

Measurement of latency can be based, for example, upon a “ping” command, which is a utility to determine whether a specific network address is accessible. With the ping command, a data packet is sent to a specified address and time is measured until the specified address provides a return packet. In one embodiment, the latency determination logic 110 determines the latency to be about one-half of the period of time from sending of the data packet to receipt of the return packet.

In another embodiment, the latency determination logic 110 can issue a pre-determined quantity of ping commands and determines latency based on the longest observed latency. In this manner, anomalies associated with routing delays for various paths that may exist between the first node and the second node can be taken into account.

In yet another embodiment, the latency can be based upon predetermined values. For example, with respect to a private network with a known topology, predetermined latency can be stored (e.g., in a lookup table). By way of illustration, Table 1 (shown below) depicts example communication latencies between a network having nodes A, B and C. If the locations of network nodes are known, then the latency between them can be measured and stored. Of course, estimates can also be used.

TABLE 1

| Node 1 | Node 2 | Latency |
|---|---|---|
| A | B | 15 ms |
| B | C | 90 ms |
| A | C | 25 ms |

The determined latency signal 115 can then be based, at least in part, upon the stored latency associated with the particular nodes participating in the video conference. Those skilled in the art will recognize that latency between nodes can be determined in a variety of methods. All such methods are intended to be encompassed by the hereto appended claims.

With further reference to FIG. 1, in one embodiment, the adjustment signal 125 is provided to optimize latency of the encoder for the benefit of the entire network and not for optimization of the encoder. Via the adjustment signal 125, the encoder adjustment logic 120 can affect latency of the encoder (e.g., increase, decrease and/or leave unmodified) by adjusting the encoding process used by the encoder.

Based, at least in part, upon the determined latency signal 115, the encoder adjustment logic 120 can provide the encoder adjustment signal 125. The adjustment signal 125 can be configured to adjust latency of the encoder in a variety of ways. For example, assuming the encoder is a variable bit-rate encoder, the adjustment signal 125 can provide one or more encoding parameters for the encoder to employ that reduces the bit-rate, which increases latency and thus conserves bandwidth. In other examples, the adjustment signal 125 can set a quantity of buffer frames, identify one of a plurality of available encoders to employ and/or identify one of a plurality of compression algorithms to employ (e.g., Moving Picture Experts Group (MPEG), MPEG-2, MPEG-4, International Telecommunication Union (ITU) H.216, ITU H.263, H.264 and the like). It will be appreciated that the types of parameters that can be selected to adjust the encoder will vary based on the type of encoder used and the type of available parameters that are configured with the encoder (codec).

The decision to adjust latency and the extent to which the latency can be adjusted can be based on a threshold latency value. A threshold latency value is an acceptable network latency where video quality is not significantly impacted. For example, an 80-millisecond latency may have been determined to be an acceptable threshold latency where a video conference session has acceptable quality and speed. This may be determined based on user satisfaction with video conference sessions operating at the threshold latency, other user perceptions of quality, and/or a selected value.

For a selected network connection between nodes, the determined latency can be compared to the threshold latency. If the determined latency is less than the threshold (e.g., predetermined latency threshold and/or dynamically determined latency threshold), the adjustment signal 125 can be set to provide information associated with increasing latency to reduce bandwidth consumption. If the determined latency is greater than the threshold, the adjustment signal 125 can be set to provide information associated with decreasing latency (e.g., to increase quality of the video conference resulting in increased bandwidth consumption). Finally, if the determined latency is at or about the threshold, the latency can be left unmodified (e.g., no adjustment signal 125 provided and/or adjustment signal 125 left unmodified).

By appropriate threshold selection, bandwidth can be conserved without a significant impact on conference quality. Conference attendees generally are unaware of the increased connection latency as it is below an acceptable latency level.

Next, with respect to a multipoint network connection (e.g., more than two nodes), a determined latency signal 115 can be obtained for each site. The encoder adjustment logic 120 can then provide an adjustment signal 125 based on the determined latency signal 115 (e.g., on the longest determined latency). In one embodiment, the encoder adjustment logic 120 can further provide an adjustment signal 125 based on latency information received from one or more of the one or more sites (e.g., adjusted to balance and/or equalize latency between multiple nodes, for example, to be within a specified tolerance).

In one embodiment, the encoder adjustment logic 120 can provide the adjustment signal 125 based on information associated with the video conference to be conducted between the nodes. For example, with a paid video conference service, transmission quality (e.g., high, medium, low) can be proportional to a price paid. Thus, latency associated with a video conference of a customer who deemed a low quality video conference acceptable can be increased to reduce bandwidth.

In another embodiment, the encoder adjustment logic 120 can perform a static adjustment based on the determined latency signal 115. For example, for a determined latency signal 115 of 15 milliseconds (ms) and a predetermined threshold of 80 ms, the encoder adjustment logic 120 can provide an adjustment signal 125 to increase latency by 65 ms (e.g., relative adjustment value). Alternatively, the encoder adjustment logic 120 can provide an adjustment signal 125 to increase latency to 80 ms (e.g., absolute adjustment value). Of course, the encoder may not be capable of being set to a selected latency but rather can be adjusted to change its encoding process in ways that are known to increase latency.

In yet another embodiment, the encoder adjustment logic 120 can dynamically determine the encoder adjustment signal 125 based, at least in part, upon the determined latency signal 115 and additional information. For example, the encoder adjustment logic 120 can employ information regarding network traffic, network topology and/or anticipated network bandwidth. Thus, the encoder adjustment logic 120 can be made to adapt to system changes.

In another embodiment, after the encoder adjustment signal 125 has been provided to the encoder, the controller 100 can again determine latency between the first node and the second node to confirm that the encoder adjustment signal 125 had the intended effect on latency. In the event that the desired latency has not been achieved, the encoder adjustment signal 125 can be modified as discussed previously. Thus, the adjustment signal 125 can be adaptively modified based on observed conditions. The observed conditions can further include, for example, in-room performance feedback (e.g., adjustment of latency of an encoder until the room performance is satisfactory).

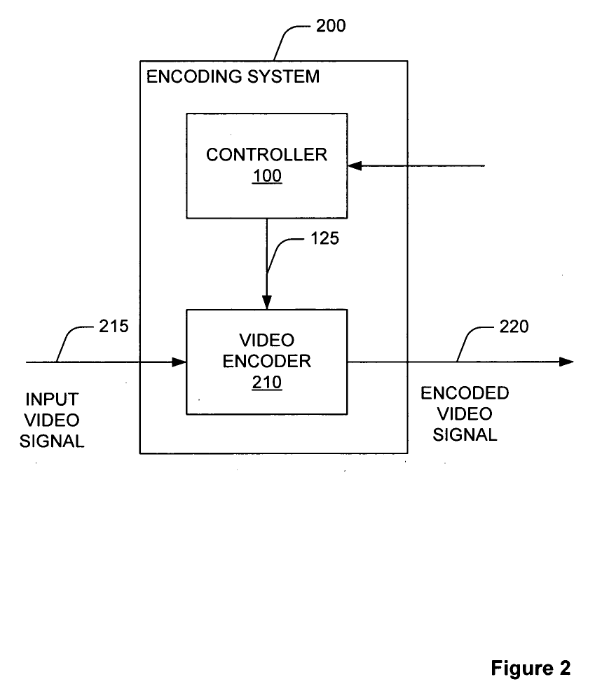

FIG. 2 is a block diagram that illustrates an example video encoding system 200. The system 200 includes the controller 100 and a video encoder 210. The video encoder 210 can be configured based, at least in part, upon the adjustment signal 125 to achieve the desired latency. Once configured, the video encoder 210 can receive a video signal 215, encode the signal 215, and provide an encoded video signal 220 output.

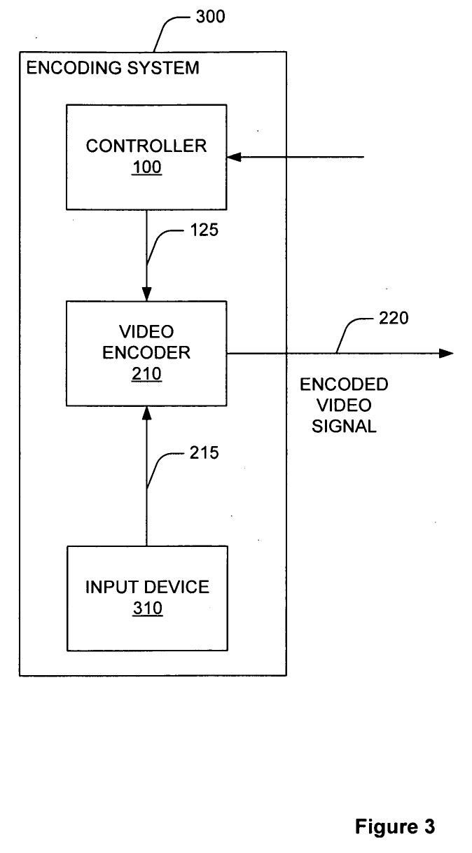

FIG. 3 is a block diagram that illustrates an example video encoding system 300. The system 300 includes the controller 100, the video encoder 210 and an input device 310 (e.g., video camera(s) and/or microphone(s)). The input device 310 provides the video signal 215 that the video encoder 210 can encode.

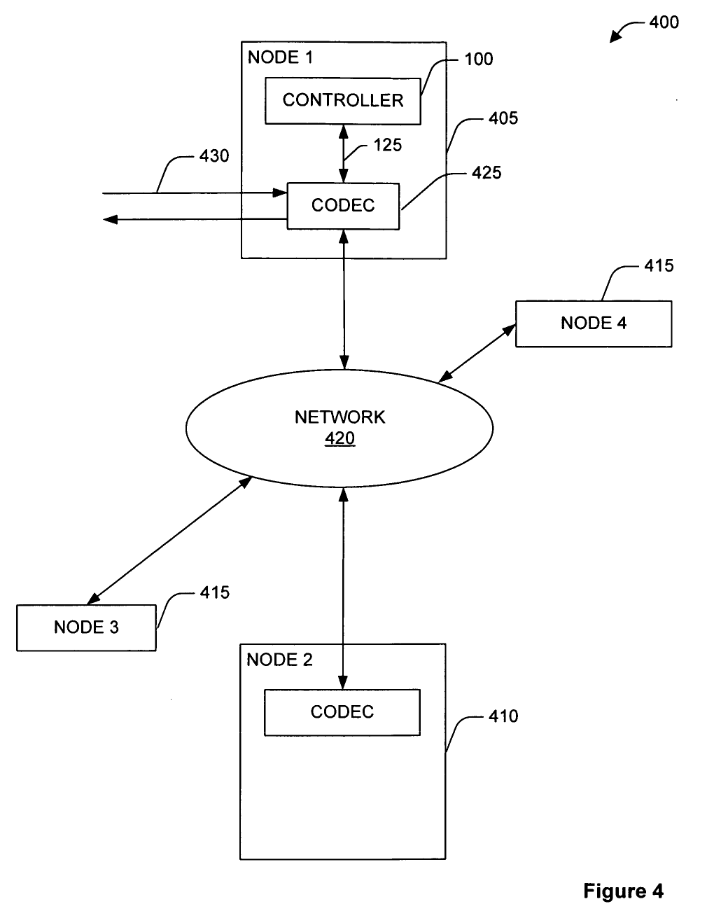

FIG. 4 is a block diagram that illustrates an example video conference system 400. The system 400 includes a first node 405 and a second node 410. The system 400 may include one or more additional nodes 415. The nodes 405, 410, 415 are connected to a network 420 (e.g., private network and/or the Internet) using an appropriate network interface(s).

The first node 405 includes the controller 100 and a coder/decoder (codec) 425. The controller 100 provides an encoder adjustment signal 125 that the codec 425 employs when encoding video signal 430.

The following is one example of operation of the controller 100. Suppose node 1 405 and node 2 410 have a video conferencing session established between them over the network 420 and that node 3 and node 4 have a video conferencing session between them. Further suppose that node 1 and node 2 are geographically located relatively close to each other, for example, within the same building, state or country. Thus, the network latency between node 1 and node 2 may be determined by the controller 100 to be relatively low (e.g. 10 milliseconds). Assume node 3 and node 4 are on different continents and thus have a higher latency like 200 milliseconds.

The controller 100 can then determine if the codec 425 of node 1 should be adjusted in order to optimize the overall network latency. For example, let's assume that an acceptable network latency has been determined to be 85 milliseconds (ms) and this is set as the threshold latency. By comparing the network latency of 10 ms between nodes 1 and 2 with the threshold latency of 85 ms, the controller 100 can decide to adjust the codec 425 of node 1 causing an increase in latency. The latency can be increased in this example by 1 ms to at least 85 ms or more, if desired, without significantly affecting video conferencing quality.

As previously explained, the encoding process used by codec 425 can be adjusted such as by reducing bit-rate, using a lower quality compression algorithm, changing other available parameters in the codec 425, and/or by selecting a lower bandwidth-higher latency codec (if other codecs are available for selection). By increasing the latency between nodes 1 and 2, additional network bandwidth may be made available for nodes 3 and 4, which may decrease the latency between them. In this manner, by selectively increasing latency between certain nodes, the overall perceived network latency can be maintained closer to an acceptable level for many nodes.

It is to be appreciated that one or more of the nodes 405, 410, 415 can include a controller 100 that can provide an encoder adjustment signal 125 for its associated node. Additionally, the encoder adjustment signal 125 can be provided by the first node 405 to one or more additional nodes 410, 415 for use in encoding a video signal associated with the particular node 410, 415. The encoder adjustment signal 125 can further be provided to one or more of the nodes 405, 410, 415 by a central server to balance network traffic.

Example methods may be better appreciated with reference to flow diagrams. While for purposes of simplicity of explanation, the illustrated methods are shown and described as a series of blocks, it is to be appreciated that the methods are not limited by the order of the blocks, as some blocks can occur in different orders and/or concurrently with other blocks from that shown and described. Moreover, less than all the illustrated blocks may be required to implement an example method. In some examples, blocks may be combined, separated into multiple components, may employ additional, not illustrated blocks, and so on. In some examples, blocks may be implemented in logic. In other examples, processing blocks may represent functions and/or actions performed by functionally equivalent circuits (e.g., an analog circuit, a digital signal processor circuit, an application specific integrated circuit (ASIC)), or other logic device. Blocks may represent executable instructions that cause a computer, processor, and/or logic device to respond, to perform an action(s), to change states, and/or to make decisions. While the figures illustrate various actions occurring in serial, it is to be appreciated that in some examples various actions could occur concurrently, substantially in parallel, and/or at substantially different points in time.

It will be appreciated that electronic and software applications may involve dynamic and flexible processes and thus that illustrated blocks can be performed in other sequences different than the one shown and/or blocks may be combined or separated into multiple components. In some examples, blocks may be performed concurrently, substantially in parallel, and/or at substantially different points in time.

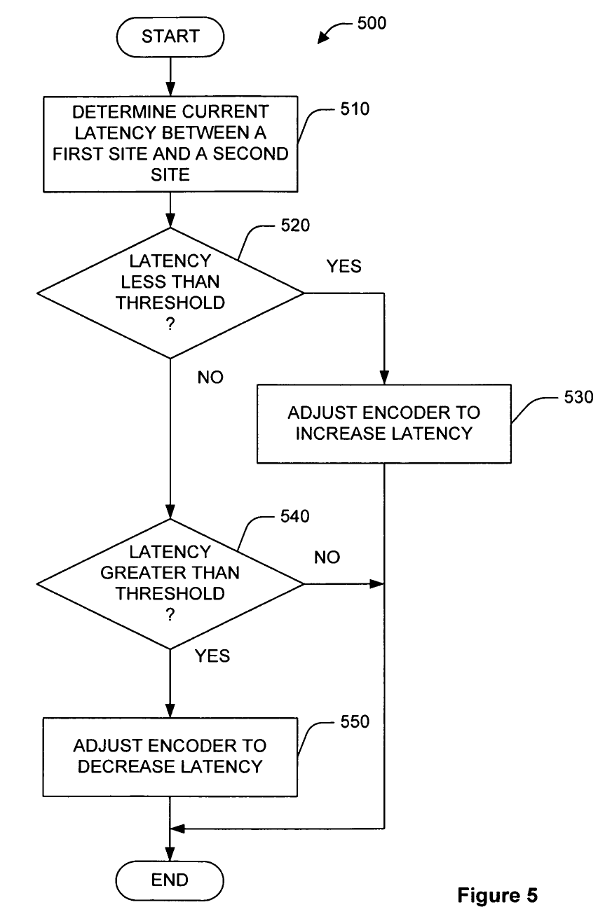

FIG. 5 illustrates an example method 500 of modifying a video conference encoding system. At 510, latency between a first site and a second site is determined (e.g., measured via ping command). At 520, a determination is made as to whether the latency is less than a threshold. If the determination at 520 is YES, at 530, a signal is provided to an encoder to increase latency and method 500 ends.

If the determination at 520 is NO, then the method can make no adjustment, or at 540, a determination can be made as to whether the latency is greater than the threshold. If the determination at 540 is YES, at 550, a signal is provided to an encoder to decrease latency and then method 500 ends. If the determination at 540 is NO, then the encoder is not adjusted.

In one example, the method 500 is implemented as processor executable instructions and/or operations stored on or provided by a machine-readable medium. Thus, in one example, a machine-readable medium may store or provide processor executable instructions operable to perform some or all of the method 500 that includes the method of modifying a video conference encoding system. While the above method is described being stored on or provided by a machine-readable medium, it is to be appreciated that other example methods described herein may also be implemented as processor executable instructions stored on or provided by a machine-readable medium.

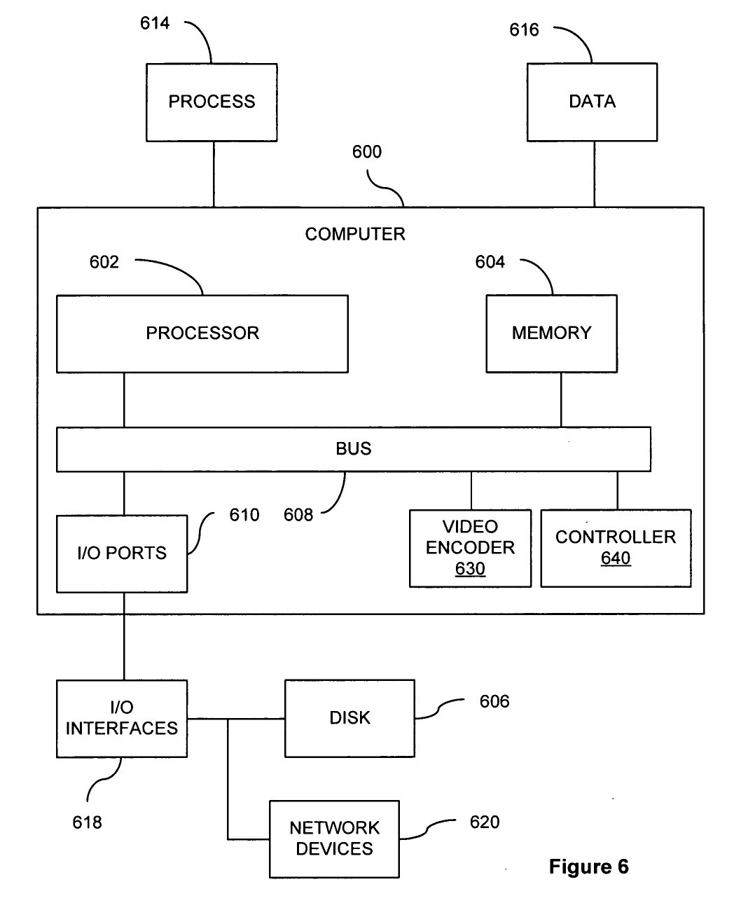

FIG. 6 illustrates an example computing device in which example systems and methods described herein, and equivalents, may operate. The example computing device may be a computer 600 that includes a processor 602, a memory 604, and input/output ports 610 operably connected by a bus 608. In one example, computer 600 may include a video encoder (codec) 630 and a controller 640 configured to adjust a video encoder based on latency between video conference nodes. In different examples, controller 640 may be implemented in hardware, software, firmware, and/or combinations thereof. Thus, controller 640 may provide means (e.g., hardware, software, firmware) for adjusting a video encoder 630. While controller 640 is illustrated as a hardware component attached to bus 608, it is to be appreciated that in one example, logic 630 could be implemented in processor 602. The video encoder 630 can be implemented in software and/or hardware.

Generally describing an example configuration of computer 600, processor 602 may be a variety of various processors including dual microprocessor and other multi-processor architectures. Memory 604 may include volatile memory and/or non-volatile memory. Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), and direct RAM bus RAM (DRRAM).

Disk 606 may be operably connected to the computer 600 via, for example, an input/output interface (e.g., card, device) 618 and an input/output port 610. Disk 606 may be, for example, a magnetic disk drive, a solid state disk drive, a floppy disk drive, a tape drive, a Zip drive, a flash memory card, and/or a memory stick. Furthermore, disk 606 may be a CD-ROM, a CD recordable drive (CD-R drive), a CD rewriteable drive (CD-RW drive), and/or a digital video ROM drive (DVD ROM). Memory 604 can store processes 614 and/or data 616, for example. Disk 606 and/or memory 604 can store an operating system that controls and allocates resources of computer 600.

Bus 608 may be a single internal bus interconnect architecture and/or other bus or mesh architectures. While a single bus is illustrated, it is to be appreciated that computer 600 may communicate with various devices, logics, and peripherals using other busses (e.g., PCIE, SATA, Infiniband, 1394, USB, Ethernet). Bus 608 can be types including, for example, a memory bus, a memory controller, a peripheral bus, an external bus, a crossbar switch, and/or a local bus. The local bus may be, for example, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

Computer 600 may interact with input/output devices via i/o interfaces 618 and input/output ports 610. Input/output devices may be, for example, a keyboard, a microphone, a pointing and selection device, cameras, video cards, video display(s), disk 606, network devices 620, and so on. Input/output ports 610 may include, for example, serial ports, parallel ports, and USB ports.

Computer 600 can operate in a network environment and thus may be connected to network devices 620 via i/o interfaces 618, and/or i/o ports 610. Through the network devices 620, computer 600 may interact with a network. Through the network, computer 600 may be logically connected to remote computers. Networks with which computer 600 may interact include, but are not limited to, a local area network (LAN), a wide area network (WAN), and other networks. In different examples, network devices 620 may connect to LAN technologies including, for example, optical carrier (OC) such as DS3, OC3 and higher links etc., fiber distributed data interface (FDDI), copper distributed data interface (CDDI), Ethernet (IEEE 802.3), token ring (IEEE 802.5), wireless computer communication (IEEE 802.11), and Bluetooth (IEEE 802.15.1). Similarly, network devices 620 may connect to WAN technologies including, for example, point to point links, circuit switching networks (e.g., integrated services digital networks (ISDN)), packet switching networks, and digital subscriber lines (DSL).

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. The term “and/or” is used in the same manner, meaning “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A controller, comprising:
a latency determination logic to determine latency between a first video conference node and a second video conference node; and,
an encoder adjustment logic to adjust latency of a video encoder based, at least in part, upon the determined latency.

2. The controller of claim 1, where the encoder adjustment logic causes the latency of the video encoder to increase if the determined latency is less than a threshold in order to decrease bandwidth consumed by the video encoder.

3. The controller of claim 1, where adjustment of the encoder latency comprises a decrease of latency if the determined latency is greater than a threshold.

4. The controller of claim 1, where adjustment of the encoder latency comprises modification of at least one parameter of the encoder.

5. The controller of claim 4, where the parameter is a bit-rate of the encoder.

6. The controller of claim 1, where adjustment of the encoder latency comprises selection of one of a plurality of encoding algorithms.

7. The controller of claim 6, at least one of the plurality of encoding algorithms is based on Moving Picture Experts Group (MPEG), MPEG-2, MPEG-4, ITU H.261, ITU H.273 or H.264.

8. The controller of claim 1, where the video encoder is a coder/decoder (codec).

9. A video conferencing system comprising the video encoder and the controller of claim 1.

10. The controller of claim 1, where the latency determination logic determines latencies between the first video conference node and a plurality of nodes and the encoder adjustment logic adjusts the video encoder based, at least in part, on the determined latencies.

11. The controller of claim 10, where the encoder adjustment logic further adjusts the video encoder based, at least in part, on latency information received from one or more of the plurality of nodes.

12. A method of modifying a video conference encoding system, comprising:
determining latency between a first site and a second site; and,
adjusting encoding latency based, at least in part, upon the determined latency.

13. The method of claim 12, adjusting encoding latency further comprising:
increasing latency if the determined latency is less than a threshold; and,
decreasing latency if the determined latency is greater than the threshold.

14. The method of claim 12, where adjusting encoding latency comprises selection of one of a plurality of encoders.

15. The method of claim 12, where adjusting encoding latency comprises modification of at least one setting of an encoder.

16. The method of claim 15, where the setting relates to a bit-rate of the encoder.

17. The method of claim 12 being implemented by processor executable instructions provided by a machine-readable medium.

18. A video encoding system, comprising:
means for determining a network latency between a first video conference node and a plurality of video conference nodes;
means for adjusting a video encoding process to increase latency if the determined network latency is less than a threshold; and,
means for encoding a video signal using the adjusted video encoding process.

19. The system of claim 18, further comprising means for adjusting the video encoding process to decrease the network latency if the determined network latency is greater than the threshold.

20. The system of claim 18 being implemented as a computer system including a video display.

21. The system of claim 18 being embodied on a computer-readable medium comprising processor executable instructions.
